(19) United States
(12) Patent Application Publication
(10) Pub. No.: US 2013/0161111 A1
(43) Pub. Date: Jun. 27, 2013

(54) MOUNTING STRUCTURE OF THREE-CYLINDER ENGINE

(71) Applicants: Yong-Joo Kim, Seoul (KR); Min-Sup Lee, Yongin-shi (KR); Yong-Jin Kim, Gwangmyeong-shi (KR)

(72) Inventors: Yong-Joo Kim, Seoul (KR); Min-Sup Lee, Yongin-shi (KR); Yong-Jin Kim, Gwangmyeong-shi (KR)

(73) Assignees: Kia Motors Corporation, Seoul (KR); Hyundai Motor Company, Seoul (KR)

(21) Appl. No.: 13/614,392

(22) Filed: Sep. 13, 2012

(30) Foreign Application Priority Data
Dec. 21, 2011 (KR) 10-2011-139014

(51) Int. Cl. B60K 5/12; B60K 17/00

(52) U.S. Cl. 180/292

(57) ABSTRACT

A mounting structure of a three-cylinder engine is mounted in a car body transversely but is installed on engine and transmission mounts built on opposing sides in the width direction of the vehicle so that its weight can be supported, wherein a roll mount controls roll moment. The center of mass of the engine and the transmission is the center of rotation where a longitudinal pitch axis, a lateral roll axis and a vertical yaw axis all cross each other, but the roll mount is combined with the engine or the transmission so that the combination point lies on the yaw axis. The mounting structure can improve the NVH performance by suppressing the pitch moment and inducing the yaw moment and by more efficiently insulating the vibration caused by the yaw moment while maintaining the common platform.

### CROSS-REFERENCE TO RELATED APPLICATION

The present application claims priority of Korean Patent Application Number 10-2011-0139014 filed Dec. 21, 2011, the entire contents of which application is incorporated herein for all purposes by this reference.

### BACKGROUND OF INVENTION

1. Field of Invention

The present invention relates to a mounting structure of a three-cylinder engine, and more particularly, to a mounting structure of a three-cylinder engine in which the vibration is reduced when the engine is idling by inducing the yaw moment having the yaw axis as the axis of rotation and insulating it in order to solve the problems of mounting of a three-cylinder engine generating relatively more vibration compared to mounting of a four-cylinder engine.

2. Description of Related Art

The need to improve fuel efficiency when developing a vehicle is increasing, and hence, efforts to decrease the size and the weight of an engine are being made.

Also, in order to prevent the decline in output due to the downsizing of an engine, sometimes BSM (Balance Shaft Module) is deleted in case of an engine with low engine displacement.

As such, A three-cylinder engine without BSM has been developed, and usually this kind of a three-cylinder engine is mounted on a light-weight vehicle.

The traditional three-cylinder engine is combined with a transmission and installed transversely, but it is mounted in a way that, as illustrated in FIG. 1a, on both sides of the torque roll axis (an arbitrary axis determined by a crank shaft and principal axis of inertia, on which the rotary motion occurs when a couple of forces are applied centering the crank shaft) are arranged an engine mount and a transmission, and a roll mount (installed on the sub-frame) is connected either to the engine or the lower part of the transmission so that the excitation force in the roll-direction is insulated.

However, while a four-cylinder engine or a six-cylinder engine is composed so that each of its pistons spins the crank shaft 90 degrees or 60 degrees during the one full revolution of the crank shaft (360-degree revolution), a three-cylinder engine is composed so that each of its pistons spins the crank shaft 120 degrees during the one full revolution of the crank shaft, and therefore structurally a three-cylinder engine generated more vibrations.

Such vibrations (illustrated in FIG. 1b) trigger the yaw moment and the pitch moment not only in the direction of a roll axis but in the directions of a yaw axis and a pitch axis.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

In other words, a three-cylinder engine, in comparison with a four-cylinder engine, is inferior in NVH (Noise, Vibration and Harshness) (especially when idling). The excitation force by the pitch moment and the yaw moment plays a big part in this NVH performance decline.

Also, usually a pitch moment and a yaw moment, which occurs in a three-cylinder engine, occurs in half-and-half couplings. Thus, in mounting of a three-cylinder engine, there is a need to offset the excitation force by the pitch moment and the yaw moment.

Various aspects of the present invention provide for a mounting structure of a three-cylinder engine with improved NVH performance by having a composition in which the inertia supporting method (a method of building an engine mount and a transmission mount on both sides of a torque roll axis or an inertia main axis to support the static load and building a roll mount perpendicular to the inertia main axis to control roll moment), which is widely used in a small-size vehicle's platform, is maintained so that it does not violate the platform commonality, but in case of a certain amount of vibrations, it induces only the vibrations by the yaw moment (and suppresses the pitch moment) and offsets the vibrations by the yaw moment.

The technical problems that the present invention is set out to solve are not limited to the ones mentioned above, and those that are not mentioned shall be clearly understood by a person skilled in the art from the specification of the present invention.

Various aspects of the present invention provide for a three-cylinder engine combined with a transmission and mounted in the car body transversely, but it is installed on the engine mount and the transmission mount built on its both sides in the direction of the full width of the vehicle so that its weight can be supported, wherein, a roll mount is connected to its lower part so that the roll moment can be controlled, the center of mass of the engine and the transmission is the center of rotation where the pitch axis is in the direction of the full length of the vehicle, the roll axis in the direction of the full width of the vehicle and the yaw axis in the vertical direction of the vehicle all cross each other, but the roll mount is combined with the engine or the transmission so that the combination point lies on the yaw axis.

In addition, in various embodiments, a second roll mount can be additionally mounted in a way that the combination point lies on the yaw axis.

Furthermore, the engine mount and the transmission mount comprises of a elastic bush made of elastic materials, and a bush axis combined with the elastic bush and connected to the engine or the transmission, and yet, the elastic bush is composed so that the force generating elastic deformation in the full length direction is smaller than the forces generating elastic deformation in the full width direction and the vertical direction.

In various aspects of the present invention, the end of the bush axis points in the full length direction.

Also, the crank shaft installed in the engine has a disc-shaped drive plate for conveying the power to the transmission installed on one end, and has a disc-shaped damper pulley, which a belt is connected to, installed on the other end, and yet, when the crank shaft rotates, a mass with a fixed mass is installed in a drive plate or damper pulley or both so that the excitation force generated in the engine and the transmission is directed to suppress the pitch moment and increase the yaw moment.

The present invention having the composition described above can improve the NVH performance by suppressing the pitch moment (pitch-axis rotation) and inducing the yaw moment (yaw-axis rotation) and by more efficiently insulating the vibration caused by the yaw moment while maintaining the common platform.

Also, the yaw moment can be more efficiently insulated because a second roll mount is additionally installed on the upper part of the engine, and the engine mount and the transmission mount are installed in the full-length direction.

Furthermore, since a mass is added to the crank shaft, the excitation force due to the engine start can be even more efficiently converted to the yaw moment.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1a is a drawing illustrating a traditional mounting structure of a three-cylinder engine.

FIG. 1b is a drawing illustrating the yaw axis, pitch axis and roll axis as they appear in the center of mass of a three-cylinder engine and the transmission.

FIG. 2 is a perspective view illustrating an exemplary mounting structure of a three-cylinder engine according to the present invention.

FIG. 3 is a drawing illustrating the side view of an exemplary three-cylinder engine of the present invention with a roll mount and a second roll mount installed on it.

FIG. 4a is a perspective view of an exemplary engine mount according to the present invention.

FIG. 4b is a perspective view of an exemplary transmission mount according to the present invention.

FIG. 5 is a perspective view illustrating an exemplary crank shaft installed inside a three-cylinder engine of the present invention.

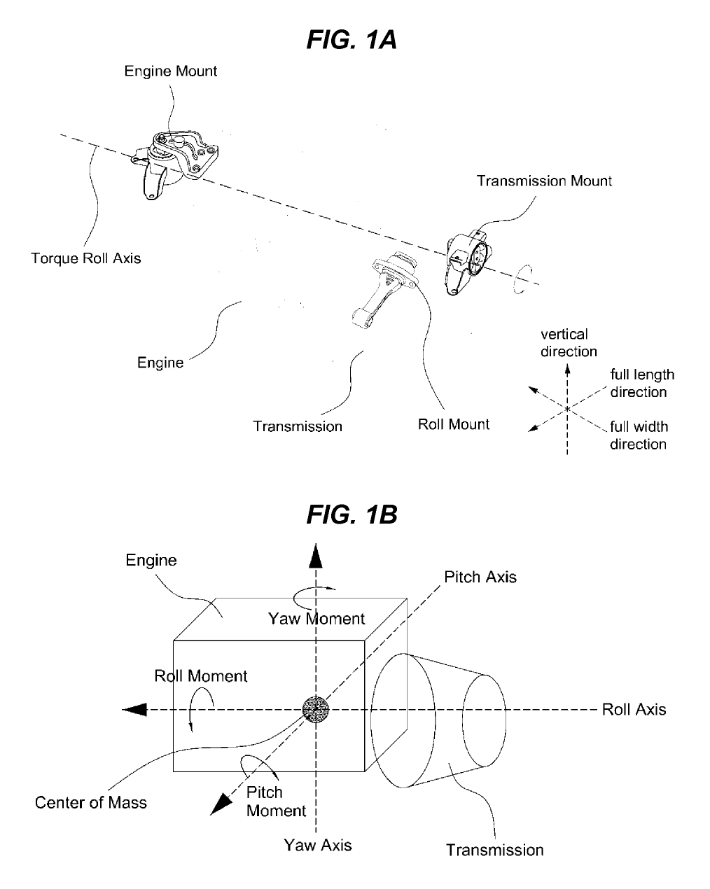

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

A three-cylinder engine (1) of the present invention is combined with a transmission (2) and mounted on the car body transversely. And, it is installed on an engine mount (20) and a transmission mount (30) built on both sides in the full-width direction, and in the lower part, a roll mount (10) installed on a subframe is connected.

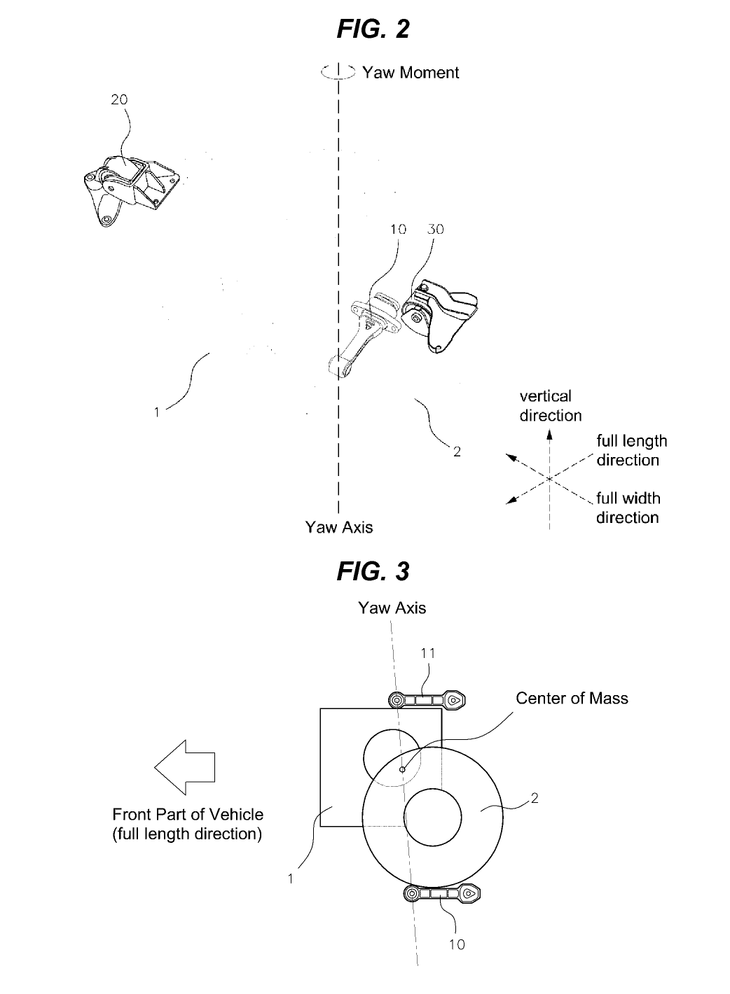

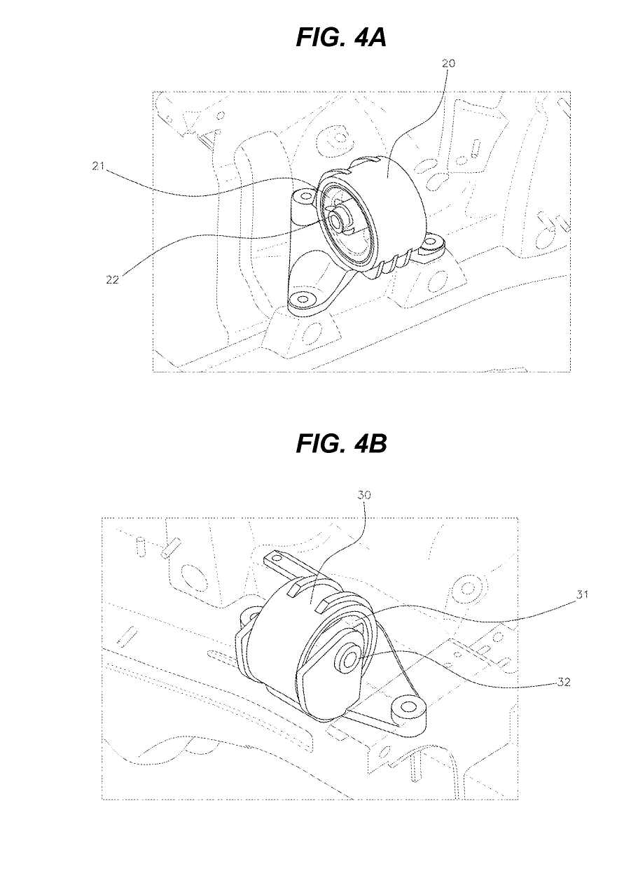

As illustrated in FIG. 2, the engine mount (20) and a transmission mount (30) support the weights of an engine and a transmission respectively, and a roll mount (10) is installed so that it controls the roll moment of an engine (1) and a transmission (2)

As illustrated in FIG. 3, the roll mount is combined so that its mounting point lies on yaw axis passing through the center of mass (of an engine and a transmission). Also, a second roll mount (11) can be selectively installed on the upper part of the yaw axis.

The second roll mount (11) can be fixed on a car body's side member, cross member, or a frame or a bar installed separately so as to be connected to an engine (10) or a transmission (2).

Meanwhile, an engine mount (20) and a transmission mount (30) of the present invention are respectively composed of elastic bushes (21, 31) and the a bush axis, which is combined with the elastic bushes (21, 31) to be connected by bolting with each of an engine (1) and a transmission (2).

The elastic bushes (21, 31) are made of synthetic rubber materials so that they have a certain amount of elasticity, and the bush axes (22, 32) are combined in the middle of the elastic bushes (21, 31) but they are installed in a way that their both ends face the full-length direction.

The elastic characteristics of the elastic bushes (21, 31) are that the force causing the elastic deformation in the full length direction (the pitch axis direction) is smaller than the forces causing the elastic deformation in the full width direction (the roll axis direction) and the vertical direction (the yaw axis direction) (for the purpose of insulating the excitation force by the induced yaw moment more efficiently).

In other words, the engine mount (20) and the transmission mount (30) are same in size with an engine (1) and a transmission (2), and they are arranged so that, when the yaw moment, the pitch moment and the roll moment occur, they are elastically deformed the most in relation to the yaw moment.

In addition, a disc-shaped drive plate (41) for conveying the force to a transmission (2) is installed on one end of a three-cylinder engine (1) of the present invention, a damper pulley (42), which a belt is connected to, is installed on the other end, and a crank shaft (40) which rotates as the piston moves up and down, is installed on it.

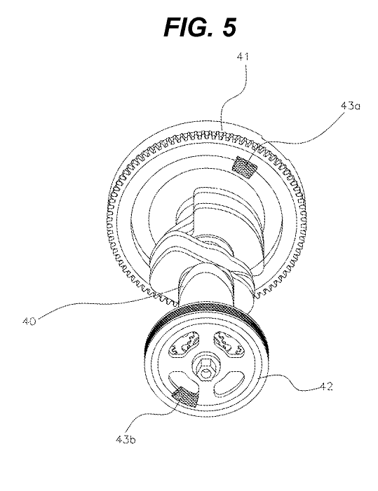

As illustrated in FIG. 5, masses (43a, 43b) with a fixed mass are installed the crank shaft (40) so that yaw moment is induced (and the pitch moment is suppressed when the excitation force occurs according to the movement of an engine).

The masses (43a, 43b) are installed in a drive plate (41) or damper pulley (42) or both so that the excitation force generated in an engine (1) and a transmission (2) is directed to suppress the pitch moment and increase the yaw moment.

For convenience in explanation and accurate definition in the appended claims, the terms upper or lower, front or rear, inside or outside, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A mounting structure of a three-cylinder engine combined with a transmission and mounted in a car body transversely, wherein the engine is installed on an engine mount and a transmission mount on opposing sides in a width direction of a vehicle so that its weight can be supported, wherein:
a roll mount is connected to a lower part of the engine so that a roll moment can be controlled; and
a center of mass of the engine and the transmission is the center of rotation where a pitch axis is in a length direction of the vehicle, a roll axis in the width direction of the vehicle and a yaw axis in a vertical direction of the vehicle all intersect one other; but
the roll mount is oriented with respect to the engine or the transmission such that that a mounting point lies on the yaw axis.

2. A mounting structure of a three-cylinder engine according to claim 1, wherein;
a second roll mount is mounted in a way that a second mounting point lies on the yaw axis.

3. A mounting structure of a three-cylinder engine according to claim 1:
wherein the engine mount and the transmission mount each include an elastic bush having a bush axis respectively connected to the engine and the transmission; and
wherein the elastic bush is configured so that a longitudinal force generating elastic deformation in the length direction is smaller than a lateral force generating elastic deformation in the width direction and/or the vertical direction.

4. A mounting structure of a three-cylinder engine according to claim 3, wherein;
the end of the bush axis extends in the length direction.

5. A mounting structure of a three-cylinder engine according to claim 1, wherein:
a crank shaft installed in the engine for conveying power to the transmission includes a disc-shaped drive plate installed on one end and a disc-shaped damper pulley, which a belt is connected to, installed on another end; and
when the crank shaft rotates, a mass with a fixed mass is installed in the drive plate and/or damper pulley so that excitation force generated in the engine and the transmission is directed to suppress pitch moment and increase yaw moment.
